(19) United States
(12) Patent Application Publication
(10) Pub. No.: US 2016/0107199 A1
(43) Pub. Date: Apr. 21, 2016

(54) WASHING SYSTEM FOR CLEANING A MOVING WEB

(71) Applicant: Owens Corning Intellectual Capital, LLC, Toledo, OH (US)

(72) Inventors: William R. Cooper, Johnstown, OH (US); Donald R. Miller, Granville, OH (US); Peter A. Dunkailo, Newark, OH (US); Lynn S. Bair, Sylvania, OH (US)

(21) Appl. No.: 14/923,207

(22) Filed: Oct. 26, 2015

Related U.S. Application Data
(62) Division of application No. 13/161,631, filed on Jun. 16, 2011, now abandoned.

(51) Int. Cl. B08B 3/02

(52) U.S. Cl. CPC B08B 3/022

(57) ABSTRACT

A washing system for cleaning a moving web includes an array of a plurality of stationary nozzles arranged in sets controlled by a control valve and operated in groups. The array includes sufficient nozzle sets each having a spray width of from 5% to 50% of the web width, such that the combined spray width of all nozzle sets is necessary and sufficient to cover substantially the entire web width with cleaning spray. Groups of valves may be operated such that some nozzle sets are turned on while other remain off, thus conserving washing fluids. The nozzles operate at pressures of 1500 to 3500 psi, or 2000 to 3000 psi. Preferably the web is a continuous loop web.

### BACKGROUND OF THE INVENTION

This invention relates in general to cleaning apparatus and, more particularly to a washing apparatus designed to clean debris from a web, such as a conveyor or foraminous chain used in the production of fiberglass insulation.

Fibrous glass insulation products generally comprise randomly-oriented glass fibers bonded together by a cured thermosetting polymeric material. Molten streams of glass are drawn into fibers of random lengths and blown into a forming chamber where they are randomly deposited onto a traveling conveyor, growing in thickness to become a fibrous pack. The fibers, while in transit in the forming chamber and while still hot from the drawing operation, are sprayed with an aqueous dispersion or solution of binder. A phenol-formaldehyde binder has been traditionally used throughout the fibrous glass insulation industry, although formaldehyde-free binders are also known. The residual heat from the glass fibers and from the flow of hot gases during the forming operation is sufficient to vaporize much of the water from the binder, thereby concentrating the binder dispersion and depositing binder on the fibers as a viscous liquid with high solids content. Further water may be removed by drying the binder on the fibers. The uncured fibrous pack is transferred to a curing oven where heated air, for example, is blown through the pack to cure the binder and rigidly bond the glass fibers together in a generally random, three-dimensional structure. Sufficient binder is applied and cured so that the fibrous pack can be compressed for packaging, storage and shipping, yet regains its thickness—a process known as “loft recovery”—when installed.

Viscous binder dispersions tend to be tacky or sticky and hence they lead to accumulation of fiber and binder solids on the forming chamber walls, the conveyor and other equipment, thereby causing undesirable dense spots or blotches in the finished product.

Various washing systems have been described in the prior art, including various spray systems having jets or sprays of water directed onto the conveyor. For example, U.S. Pat. No. 5,802,857 to Radkowski, et al, discloses such a washing system for fiberglass forming areas. On the underside of the forming conveyors, the chain is sprayed with a cryogenic liquid such as liquid nitrogen to freeze any debris on the chain. Then it is subsequently scrubbed off with rotating wire brushes before the chain recirculates to the forming area.

In other contexts, other washing systems are disclosed in U.S. Pat. No. 4,420,854 to Newton (food industry trays), U.S. Pat. No. 5,111,929 to Pierick, et al, (spiral oven cleaning system) and U.S. Pat. No. 6,230,360 to Singleton, et al, (baked goods pans).

Drawbacks in prior art washing systems include the large volume of washwater used and the need to manage the wastewater streams from these processes.

### SUMMARY OF THE INVENTION

This invention relates generally to an apparatus and method for cleaning a web such as a porous conveyor system as is typically used in the formation of fibrous mineral insulation products. Accordingly in a first aspect, the invention is an apparatus for cleaning a web having a length in one direction and a width transverse to the length direction, and also having drive means for moving the web in a length direction, the apparatus comprising:
an array of a plurality of nozzles, wherein each nozzle has a defined spray path directed toward the web and is fluidly connected to a source of washing fluid through a control valve, wherein the array of nozzles is spaced such that the combined spray paths of all of the nozzles of the array is necessary and sufficient to cover substantially the entire width of the web with sprayed washing fluid; and
control means for intermittently opening the control valves for a portion of the nozzles while the control valves for other nozzles remain closed.

In a first aspect, the invention is an method for cleaning a web, comprising:
moving a web in a length direction relative to an array of a plurality of nozzles, the web also having a width transverse to the length direction, wherein each nozzle has a defined spray path and is fluidly connected to a source of washing fluid through a control valve; and wherein the array of nozzles is spaced such that the combined spray paths of all of the nozzles of the array is necessary and sufficient to cover substantially the entire width of the web with sprayed washing fluid; and
intermittently opening the control valves for a first portion of the nozzles while the control valves for some other nozzles remain closed; and
alternately opening the control valves for a second portion of the nozzles while the control valves for some other nozzles remain closed.

In both the method and the apparatus, an array of a plurality of nozzles may comprise 3 to 24 nozzles; and they may be arranged in at least two sets, each set being controlled by a single control valve and having from 1 to 4 nozzles. The nozzles may be in a fixed transverse position relative to the web. Each nozzle spray path covers from about 5% to about 50% of the transverse width of the web, more typically from about 10% to about 25% of the transverse width of the web. In some embodiments, the spray path of each nozzle may be about 6 to about 12 inches in width at the point where it reaches the web.

In both the method and the apparatus, the nozzles may be configured to spray washing fluid at a pressure of from about 1500 to about 3500 psi, more typically from about 2000 to about 3000 psi. In some embodiments, the web is a continuous loop web that repeatedly circulates past the washing apparatus.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a partially sectioned side elevation view of a forming hood component of a manufacturing line for manufacturing fibrous products;

FIG. 2 is a partially schematic end view of a washing apparatus according to the invention; and

FIG. 3A-3E are a series of five operating conditions, A-E, showing a typical operation sequence for the washing apparatus of FIG. 2; and

FIG. 4 is a cross-section view of a flat spray nozzle suitable for use with the washing apparatus.

### DETAILED DESCRIPTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including books, journal articles, published U.S. or foreign patent applications, issued U.S. or foreign patents, and any other references, are each incorporated by reference in their entireties, including all data, tables, figures, and text presented in the cited references.

In the drawings, the thickness of the lines, layers, and regions may be exaggerated for clarity.

Unless otherwise indicated, all numbers expressing ranges of magnitudes, such as angular degrees or web speeds, quantities of ingredients, properties such as molecular weight, reaction conditions, dimensions and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements. All numerical ranges are understood to include all possible incremental sub-ranges within the outer boundaries of the range. Thus, a range of 30 to 90 degrees discloses, for example, 35 to 50 degrees, 45 to 85 degrees, and 40 to 80 degrees, etc.

“Mineral fibers” refers to any mineral material that can be melted to form molten mineral that can be drawn or attenuated into fibers. Glass is the most commonly used mineral material for fibrous insulation purposes and the ensuing description will refer primarily to glass fibers, but other mineral materials useful for insulation include rock, slag and basalt. Similarly a “fibrous mineral product” is a product made from mineral fibers.

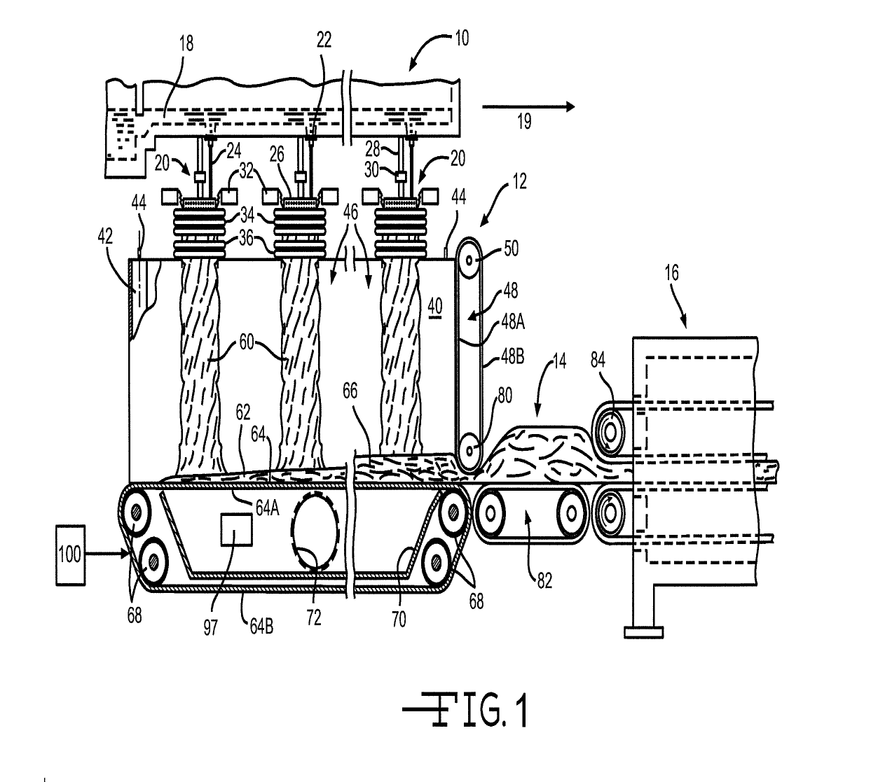

FIG. 1 illustrates a glass fiber insulation product manufacturing line including a forehearth 10, forming hood component or section 12, a ramp conveyor section 14 and a curing oven 16. Molten glass from a furnace (not shown) is led through a flow path or channel 18 to a plurality of fiberizing stations or units 20 that are arranged serially in a machine direction indicated by arrow 19 in FIG. 1. At each fiberizing station, holes or bushings 22 in the flow channel 18 allow a stream of molten glass 24 to flow into a spinner 26, which may optionally be heated by a burner (not shown). Fiberizing spinners 26 are rotated about a shaft 28 by motor 30 at high speeds such that the molten glass is forced to pass through tiny orifices in the circumferential sidewall of the spinners 26 to form primary fibers. Blowers 32 direct a gas stream, typically air, in a substantially downward direction to impinge the fibers, turning them downward and attenuating them into secondary fibers that form a veil 60 that is forced downwardly. The fibers are distributed in a cross-machine direction by mechanical or pneumatic “lappers” (not shown), eventually forming a fibrous layer 62 on a porous conveyor 64 or chain. The layer 62 gains mass (and typically thickness) with the deposition of additional fiber from the serial fiberizing units, thus becoming a fibrous “pack” 66 as it travels in a machine direction 19 through the forming area 46.

One or more cooling rings 34 spray coolant liquid, such as water, on veil 60 to cool the forming area and, in particular, the fibers within the veil. Other coolant sprayer configurations are possible, of course, but rings have the advantage of delivering coolant liquid to fibers throughout the veil 60 from a multitude of directions and angles. A binder dispensing system includes binder sprayers 36 to spray binder onto the veil 60. Illustrative coolant spray rings and binder spray rings are disclosed in US Patent Publication 2008-0156041 A1, to Cooper, incorporated herein by reference. A specific sprayer ring is discussed in provisional patent application 61/421,306, filed Dec. 9, 2010. Each fiberizing unit 20 thus comprises a spinner 26, a blower 32, one or more cooling liquid sprayers 34, and one or more binder sprayers 36. FIG. 1 depicts three such fiberizing units 20, but any number may be used. For insulation products, typically from two to about 15 units may be used in one forming hood component for one line.

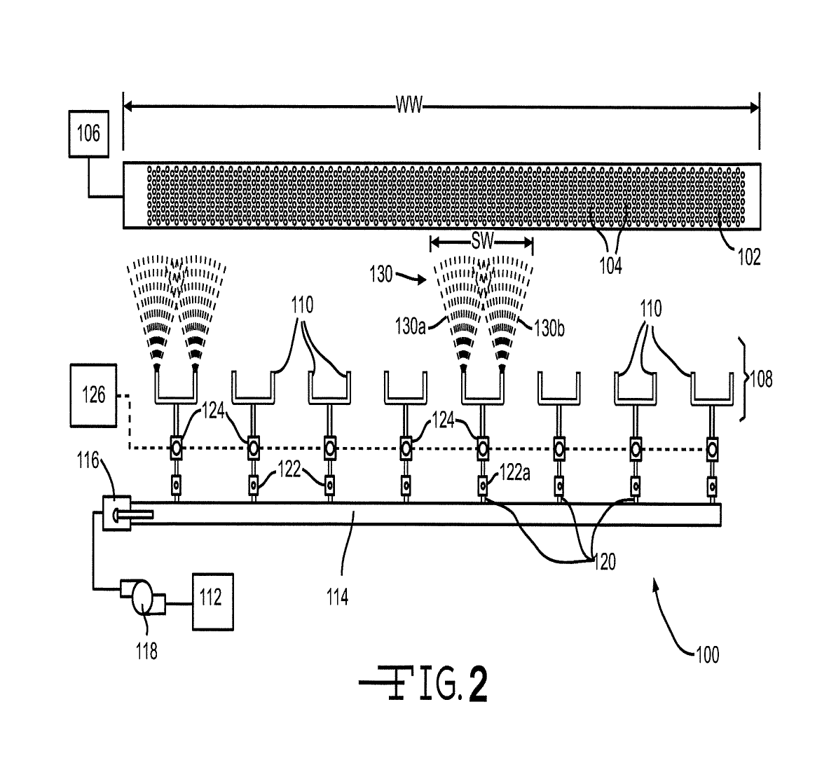

The forming hood section or component 12 is further defined by at least one hood wall 40, and usually two such hood walls on opposing sides of the conveyor 64 to define a forming chamber or area 46. For clarity in FIG. 1, the hood wall 40 is depicted on only one side (behind conveyor 64), and a portion of the wall 40 on the left end is removed to reveal a roller 42 and its axis 44. Typically, each of the hood walls 40 takes the form of a loop or belt having two flights 40A and 40B (see FIG. 2). Inward facing flight 40A defines a sidewall of the forming area 46 and moves through the forming area by rotating about vertical rollers 42; while outside flight 40B closes the loop outside of the forming area 46. End walls 48 (one shown at the right end of the forming area 46) of similar belt construction may further enclose the forming area 46 with an inward facing flight 48A and an outward return flight 48B. As shown in FIGS. 1 and 2, however, the rollers 50, 80 for the end wall 48 may be oriented transversely compared to the rollers 42. A similar end wall (not shown) may be present on the left end of the forming area 46.

The belt loop construction of these forming hood walls 40, 48 facilitates the ability to clean them separately from other downstream air components. A hoodwall cleaning system 43, typically comprising a wiper or scraper blade and a sprayer or dispenser is disposed along a leading edge of the outside flights 40B and 48B. A source of washing water is fed to the cleaning system 43 and the sprayer sprays water on the outside flight 40B of the hoodwall, thus aiding the scraper to remove debris (e.g. binder and glass fibers) that has accumulated on the hoodwall 40. The exact configuration of the cleaning system 43 is not critical.

“Forming hood components” 102 means at least one hood wall, more typically including two side hoodwalls 40 and optional end walls 48, that define the fibrous pack forming area 46 above the conveyor 64 and below the fiberizing units 20. The terms “forming hoodwall”, “hoodwall” and “hood wall” may be used interchangeably herein. While most of the binder sprayed into the forming area ends up in the fibrous pack, it has been found that as much as about 90% of the binder that does not remain in the pack accumulates instead on the hoodwalls. Only a minor portion (e.g. less than about 10% of the binder that does not remain in the pack) passes through to reach the conveyor 64, or other downstream components.

Distinct from “forming hood components” are the “downstream air components” 92, which have the primary purpose of creating and maintaining a negative pressure below the chain or conveyor 64 in order to draw through the air injected to the forming area 46 by blowers 32. The “downstream air components” 92 thus include the air handling system downstream from the conveyor 64, including the conveyor 64 itself. Note that “downstream” here refers to the direction of airflow, not the machine direction 19. Elsewhere, “downstream” is also used to describe directionality relative to the flow path of washing fluids. Conveyor 64, also known as a “chain” or “web” may also include two flights 64A and 64B. The surface of the web or conveyor 64 is foraminous or porous to allow airflow through it. In some embodiments, the chain conveyor or web is about 50% chain and 50% open. Under the influence of a drive means (not shown in FIG. 1) such as a motor, or gears or belts linked to a motor, upper flight 64A travels in the machine direction 19, revolves about one or more rollers 68 and descends to lower flight 64B which revolves about further rollers 68 before rising vertically to complete the belt web. A washing system 100, described in detail below, is disposed along the web somewhere other than upper flight 64A, for example at the leading edge where the web rises to re-enter the forming area 46.

Other downstream air components 92 are found beneath the upper flight 64A of conveyor chain 64. Here, one or more suction boxes 70 are connected via duct 72 to a drop out box 74 (refer to FIG. 5). Dropout box 74 is just one type of particle separator that decelerates the air flow to allow particulates to fall and separate from the air stream. Other particle separators might include cyclonic separators, demisters and the like. Further downstream, a forming fan or blower 76, and its housing, ultimately provide the negative pressure in the suction box 70 that aids in removing air entering the forming area 46 to reduce turbulence. A final portion of the downstream air components 92 includes further ductwork leading ultimately to a discharge stack (not shown). In spite of the negative pressure provided by the downstream air components 92, the airflow and turbulence caused by the blowers 32 frequently cause binder from sprayers 36 and glass fibers from the veil 60 to become adhered to the hood walls 40, 48 as described above.

The uncured pack 66 exits the forming hood area 46 under roller 80 and, in the absence of the downward influence of the blowers 32 and the suction box 70, (optionally aided by a pack lift fan, not shown) the uncured pack 66 immediately regains a certain degree of loft or height (“ramp height”) as it travels along the conveyor 82 toward the curing oven 16. Spaced-apart rollers or porous conveyors 84 force the pack 66 down to a desired thickness (or “bridge height”) and the product is cured at this thickness in the oven 16. The emerging cured product, or “blanket”, then continues to cutting and packaging steps.

More recently, formaldehyde-free binder systems have employed a binder comprising a polycarboxylic acid polymer and a polyol. One example of a formaldehyde-free binder composition is a polyacrylic acid polymer as described in U.S. Pat. Nos. 6,884,849 and 6,699,945 to Chen, et al. Other approaches to formaldehyde-free resins include binders made from natural starches (or dextrins or other polysaccharides of varying length) and polyfunctional organic acids like citric or maleic acids, such as those disclosed in commonly owned U.S. patent application Ser. No. 12/900,540, filed Oct. 8, 2010. In both cases, the binder dispersions are acidic due to the carboxylic acid groups. These novel acid-based binder systems, however, are best employed at low pH, for example, less than about pH 6 and often less than pH 3. The acidic solutions exacerbate corrosion of equipment; and disposal of acidic waste streams is also a problem.

Referring now to FIG. 2, a washing apparatus or system 100 is shown. The washing system 100 is positioned along the underside of a conveyor or web 102 having an overall web width (WW). In the case of forming conveyors, the web width WW may be in the range of from about 3 feet to about 16 feet, more typically from about 6 feet to about 12 feet. The web 102 may have many small foramina or orifices 104 that make it porous as noted above. The web is driven by a motor 106, shown schematically, in a “machine direction” which in the view of FIG. 2 is directly toward or away from the viewer. The web 102 also possesses a dimension in a direction transverse to the machine direction that corresponds to the web width, WW.

Although the washing system 100 is shown beneath the web 102 in FIG. 2, it may instead be near an end as shown in FIG. 1, where the web rises in transition from the lower flight to the upper flight or at the opposite end where the web descends in transition from the upper flight to the lower flight. In some variations, the sprays are directed perpendicularly against the web; in other variations, the sprays are not perpendicular but are directed at a slight angle (e.g. 5-15 degrees from perpendicular) downwardly against a vertically rising web.

Moreover, the washing system 10 may be used from outside of the loop spraying inward to clean the outside web surface, from inside the loop spraying outward to clean the inside web surface, or both in various alternative embodiments. The motor 106 may be connected to pulleys or rollers (e.g. 68 in FIG. 1) to drive the web in the machine direction. The motor connections may be by direct drive shaft, pulley and belt or gears to cause the linear motion. The washing system 10 may also be used to clean these rollers 68 and related support structures. When acidic binders are used, the washing system 100 provides an added advantage of being able to carry anticorrosion additives that can be sprayed onto the conveyor, the rollers and supporting structures by the washing system 100.

In one embodiment the web is a foraminous conveyor of a glass fiber insulation forming area as described herein, but many other types of webs are also contemplated. In other embodiments the web may be virtually any web in need of washing. The web may be solid or porous and may thus have any degree of porosity from 0% to as much as about 90%, more typically from 0% to about 70%. The length and width of the web need not have any particular relative dimensions, although generally a web length is greater than a web width. The invention is particularly useful with a web that forms a continuous loop so that the entire area of the web is repeatedly passed by the washing apparatus.

The washing system 10 comprises an array 108 of a plurality of nozzles 110. The array 108 may be arranged linearly in the transverse or width direction, but it may also be staggered so as not to be linear in the width direction. The nozzles 110 are fluidly connected to a source of washing fluid 112 though a series of conduits and control components. Washing fluid from source of washing fluid 112 is drawn by pump 118 and pumped through a main control valve 116 to a manifold 114 that spans all or nearly all the web width WW.

In general, the array 108 of nozzles 110 is stationary with respect to the ground and other structures. The web 102 is caused to move past the array of nozzles. If desired, the whole manifold and subsequent assembly, described below, may be installed on a rotatable mount (not shown) so that the assembly can be pivoted away from the web 102 about the axis of the manifold for easy replacement of the nozzles 110.

Overall washing flow rates will depend on the size of the web to be cleaned. For typical fiberglass forming chains, flow rates may be from 1 to about 4 gallons per minute (gpm), more typically from about 1.5 to about 3.0 gpm. Generally, the washing fluid is pressurized, such as by pump 118 to a pressure from about 2500 to about 3500 psi, more typically from about 3000 to about 3200 psi. Water at these high pressures impinging on the web 102 has sufficient velocity and momentum to dislodge debris that accumulates there without the need for brushes. Main control valve 116 can operate between a closed and open position to control flow of washing fluid into the manifold 114.

The composition of the washing fluid may simply be water. Water may come from a source of fresh water, gray water, pond water, well water, city water or any other makeup source. It may or may not contain detergents, surfactants, cleaners, etc. It may or may not contain other additives such as anti-corrosion agents, biocidal agents and the like.

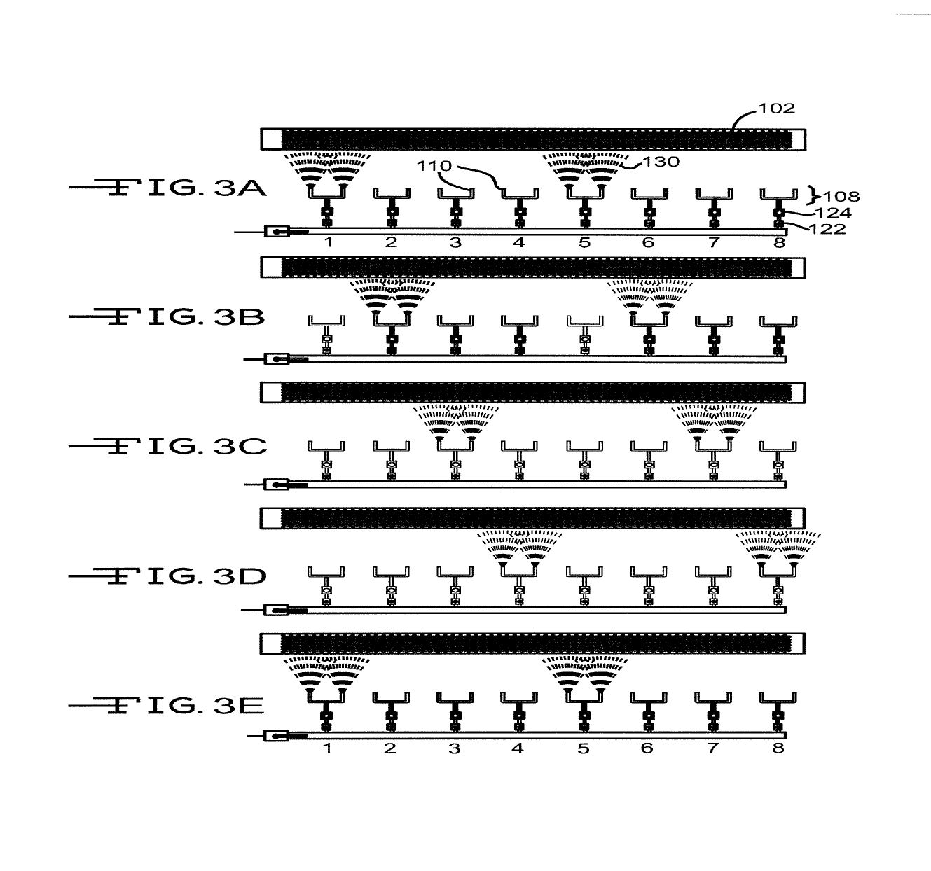

From the manifold 114, a plurality of branches 120 lead to the nozzle array 108. Eight such branches are depicted in FIG. 2, however, the number of branches 120 may be adjusted upward or downward depending on the web width WW and the spray width SW, as is described below. The flow of washing fluid in each branch 120 is controlled by control valves 122, such as ball valves, each of which is in turn controlled by a solenoid 124. The solenoids 124 are controlled by electric signals from control box 126 such that each solenoid may operate independently to open its corresponding control valve 122 to allow flow through its respective branch 120. For example, FIG. 2 depicts a first operating condition where the control valves of the first and fifth branches (from left) are open, and all other control valves are closed. This and other operating conditions will be described in more detail below in connection with FIG. 3. Solenoids are one convenient way to operate the control valves 122, but other means are described later.

Downstream (in a washing fluid flow sense) from the control valve 122, is a “set” 111 of nozzles 110. A set 111 may comprise from 1 to 4 or 5 nozzles 110, generally 1-3, the entire set being controlled by one control valve 122. For example, in FIG. 2, each branch 120 forks downstream of the control valve 122 to supply a set 111 of two nozzles 110. In this embodiment, the number of nozzles is thus an integral multiple (2×) of the number of control valves, but this need not be the case, as some branches 120 may fork and others may not. Each set 111 of nozzles 110 defines a spray pattern 130 controlled by its control valve 122 and directed toward the web 102. The spray pattern 130 has a spray width SW in the transverse or cross machine direction that is approximately the sum of individual nozzle spray patterns 130a plus 130b, minus any overlap. It will be understood that the spray pattern is generally angular, so that its width increases with distance from the nozzle 110. Spray width SW as used herein is understood to be the width of the set spray pattern at the point where the spray contacts the web 102, whatever distance that may be from the nozzle 110. It is further understood that spray width SW is the combined width of spray from the set 111 of nozzles 110. SW corresponds to the spray pattern of a single nozzle only in cases where the set 111 comprises just a single nozzle 110.

Depending on the particular nozzle configuration, the spray pattern 130 may be relatively broad and flat or it may be more conical and have a significant dimension in the machine direction as well, but this is not critical. In at least some embodiments, the spray patterns are broad and flat. It is important that the spray width SW of any one set 111 of nozzles 110 is not sufficient to cover the entire web width WW, but the combined spray widths of all nozzles of the array 108 is sufficient to cover substantially the entire web width WW. This is what is meant by the phrase “necessary and sufficient” in the context of covering substantially the entire web with sprayed washing fluid. If the combined sprays were not “necessary” then a single spray might cover the entire width; if the combined sprays were not “sufficient” then some portion of the web would remain not washed. In mathematical terms, SW<WW, but the sum of all SW≧WW. By “substantially” the entire width of the web is meant at least 75%, more typically 90% and preferably 100% is covered by combined spray widths of all nozzles 110. In some embodiments, each set 111 of nozzles 110 produces a spray width SW that covers from about 5% to about 50% of the web width WW, or more typically from about 10% to about 20% of the web width WW.

The nozzles 110 are controlled by control means for intermittently opening the control valves 122 for a portion of the nozzles 110, while the control valves 122 for other nozzles 110 remain closed. When multiple nozzles 110 exist in a set 111, the control valve 122 simultaneously controls all nozzles of the set. The control means may be manual or machine assisted; machine assistance may be mechanical, pneumatic, hydraulic or electronic or a combination of any of these. Such systems are well known and need not be described here. In at least one embodiment, the control valves 122 are operated by solenoids 124 which may be controlled from a control box 126, such as a computer or other processor unit. Remote electronic control is preferable over mechanical or manual controls.

As noted above, a set 111 of nozzles 110 are all those nozzles 110 downstream from a single control valve 122, and a set 111 defines a spray width SW, so each control valve 122 controls one spray width SW. Control valves 122 may be operated each one individually, or in groups such as pairs, triplets or even quartets if desired. When operated singly, they may be operated sequentially or non-sequentially. When operated in groups, the groups may be operated synchronously or asynchronously. Thus, in a system as shown in FIG. 2 having 8 control valves 122, the valves may be operated individually for 8 independent spray widths; or they may be operated in pairs (e.g. four groups of two spray widths); or they may be operated in quartets (e.g. two groups of four spray widths). A group of two or more valves 122 may be operated synchronously, so that each set starts and stops at the same time; or they may be operated asynchronously, where the start or stop times vary. In either case, the nozzle sets 111 comprising each group may be adjacent one another or spaced apart. An example where they are spaced apart is described below in connection with FIG. 3.

If a ninth control valve were added, these could conveniently be operated in three triplets. When valve groupings like this are used, the number of valves per group may be the same, as in the above examples, or it may differ between groups. For example, 20 nozzles arranged in 10 sets (pairs of two) might be controlled as two groups of two sets on the outsides (2L and 2R), and two groups of three sets toward the middle (3L and 3R), e.g. 2L-3L-3R-2R. These could be operated in three permutations of synchronous or asynchronous combinations:
2L and 2R together as one group, and 3L and 3R together as a second group;
2L and 3L together as one group, with 2R and 3R together as a second group; or
2L and 3R together as one group, with 2R and 3L together as a second group.
   Of course, it is also possible to operate each of the four sets independently and not operate them as groups.

The choice of how many nozzles are required to clean the width of a web surface is dependent upon the shape of the spray pattern and how far the nozzle is from the web. Alternatively, the choice of nozzle and distance from the web may be determined first as a function of the necessary velocity and pressure to clean the web. Once that is determined, the number of nozzles is more or less dictated by the width of the web. Then, the choice of how many nozzles to group in a set and how many sets to operate as a group are matters of optimization for a given web surface to be cleaned. Optimization will generally reduce overall water usage, and may obviate the need for drying the web, thus also reducing energy costs.

In one embodiment depicted in FIG. 3, the washing system 10 of FIG. 2 as described above is shown in one possible configuration or mode of operation. This configuration has 16 nozzles in eight sets of two. The sets are numbered 1 through 8. Further, the mode of operation illustrated shows that valves (i.e. nozzle sets) are grouped into spaced-apart pairs as: 1 with 5, 2 with 6, 3 with 7 and 4 with 8. It will be recalled that the web 102 is caused to move linearly past the array of nozzles during operation, in a direction toward the viewer with respect to FIG. 3. In the first mode of operation, condition A, the first group of control valves 1 and 5 are opened, while all other valves remain closed. Condition A is allowed to remain for a period of time sufficient to clean two paths or swaths of the web. Each swath is approximately the spray width SW wide.

The controls are then altered to condition B, wherein the first group of control valves 1 and 5 are closed, the second group of control valves 2 and 6 are opened, and all other control valves remain closed. Condition B is allowed to remain for a period of time sufficient to clean two more paths or swaths (of SW width) of the web. In condition C, the controls are altered again, now to close the second group of control valves 2 and 6, to open the third group of control valves 3 and 7, while all other control valves remain closed. The condition C is allowed to remain for a period of time sufficient to clean two more paths or swaths of the web. Next, condition D is depicted wherein the controls are altered again, now to close the third group of control valves 3 and 7, to open the fourth and last group of control valves 4 and 8, while all other control valves remain closed. The condition D is allowed to remain for a period of time sufficient to clean two final paths or swaths of the web. In this illustration, the swaths from each subsequent condition are adjacent to the two swaths cleaned in previous condition, although this is not essential. Condition C or D could just as easily have followed A.

Finally, in condition E the cycle repeats and the condition shown here is identical to that of condition A. The time sufficient to clean two paths or swaths of the web for each condition will vary depending on the nature of the web being cleaned, the nature of the debris on it, and lapse of time since last cleaning. For typical forming conveyor chains, it has been found that a sufficient time generally occurs in from about 0.5 to about 10 revolutions of the web, more typically in 1 to 5 revolutions. In this way, using four groups and operating conditions as illustrated in FIG. 3, the entire web is cleaned in 2 to 40 revolutions, more typically in 4 to 20 revolutions.

There are a number of advantages to the washing system 10 as described herein. First, there are few moving parts. There is no spray head that must traverse back and forth in the cross machine direction to ensure that substantially the entire width of the web is cleaned. The only moving part is the pivot of the assembly for replacement of nozzles and that is merely an optional convenience. Second, there is no need for additional brushes or scrapers to remove debris. The high pressure, flat spray nozzles at pressures mentioned herein have been found effective to remove debris from forming chain conveyors without the need for brushes. Third, the washing system of the invention utilizes less wash water and produces less waste water than prior wash systems.

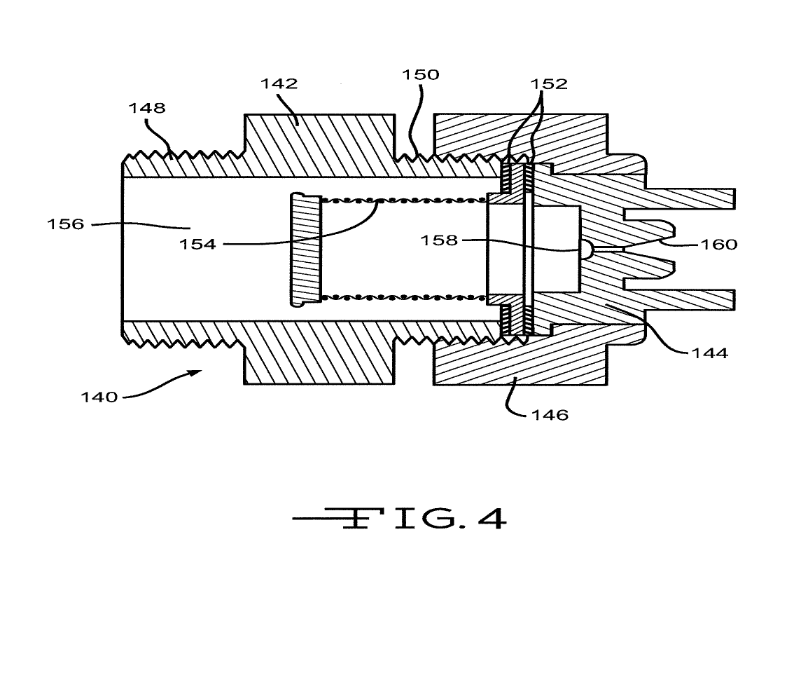

Standard, flat spray liquid pressure (LP) nozzles suitable for high pressure duty have been found to be suitable for spraying washing liquids in accordance with the invention. Generally such nozzles should be low volume, medium impact and operable in a stepped down operating pressure range of from about 500 psi to about 2000 psi, more typically from about 500 to about 1000 psi, but this will depend on the specific use. As shown in FIG. 4, the nozzle 140 generally has a nozzle body 142, a nozzle tip 144, and a retaining ring 146. First threads 148 on the body 142 are used for installing the nozzle 140 into the system; while second threads 150 are used for securing the retaining ring 146 to the body 142, the retaining ring 146 being annular for encircling and holding the nozzle tip 144 in place. Gaskets 152 and filters or mesh screens 154 are typically employed to strain out any particulate matter that might clog the nozzle. The body 142 is generally cylindrical having an open or hollow central area 156 through which cleaning liquids are pumped. This central open area 156 communicates with a central orifice 158 in the nozzle tip 144. The exact shape and dimension of the orifice 158 has much to do with the shape of the spray pattern. For flat sprays, generally a V-notch 160 is part of the orifice opening.

Such nozzles are available from Spraying Systems Company, Rosedale, N.Y., as UniJet TC models, and comparable models are available from other companies. The UniJet TC models include a tungsten-carbide orifice insert for minimal erosion, set in a stainless steel tip and retaining ring designed for pressure between 500 and 2000 psi for a wide variety of flow rates and spray widths. They may be used with stainless steel nozzle body model No. 11430 and optionally with mesh screens.

The low volume, medium-to-high impact nozzles, can accomplish the necessary cleaning with significantly less water usage, which conserves both water and costs. Additionally, when the washing systems are optimized, the need for blowers or drying jets to blow warmed, forced air on the web may be eliminated completely or at least minimized. This contributes further to conservation and reduced energy costs. However, if drying jets are needed, high efficiency jets such as air knives are useful. These drying jets (not shown) are tear-drop shaped in cross section and bring air in axially from one end. The air circulates internally and escapes vie a slot opening near the point of the “tear-drop.” The air rushing out of the slot brings with it the entrained ambient air passing over the aerodynamic tear-drop shape. Drying jets such as described above may be employed to dry the web just downstream from the washing nozzles, if desired. The drying jets may be arranged in banks much like the sets of nozzles, so that one need operate only those banks drying an area roughly corresponding to the spray width SW of an operating washer, i.e. one whose valve is open. This may result in even further energy savings. The use of drying jets may be further minimized by reducing mist generation, which can be done by angling the spray downward as noted above.

The principle and mode of operation of this invention have been explained and illustrated in its preferred embodiment. However, it must be understood that this invention may be practiced otherwise than as specifically explained and illustrated without departing from its spirit or scope.

1-10. (canceled)

11. A method for cleaning a web, comprising:
moving a web in a length direction relative to an array of a plurality of nozzles positioned across a width of the web, the width being transverse to the length direction, wherein each nozzle has a defined spray path and is fluidly connected to a source of washing fluid through a control valve; and
wherein the array of nozzles is spaced such that the combined spray paths of all of the nozzles of the array substantially covers the entire width of the web with sprayed washing fluid;
selectively opening the control valves for a first portion of the nozzles while the control valves for some other nozzles are closed; and
alternately opening the control valves for a second portion of the nozzles while the control valves for some other nozzles are closed, such that less than an entirety of the width of the web is sprayed at one time, wherein the selective opening of the control valves for a first portion of the nozzles and the control valves for a second portion of the nozzles are repeatedly cycled such that the entire web is sprayed upon only after multiple cycles.

12. The method of claim 11 wherein the array of a plurality of nozzles comprises 3 to 24 nozzles.

13. The method of claim 12 wherein the array of a plurality of nozzles are arranged in at least two sets, each set being controlled by a single control valve and having from 1 to 4 nozzles.

14. The method of claim 11 wherein each nozzle spray path covers from about 5% to about 50% of the transverse width of the web.

15. The method of claim 14 wherein each nozzle spray path covers from about 10% to about 25% of the transverse width of the web

16. The method of claim 11 wherein each nozzle is configured with a spray path of from about 6 to about 12 inches in width.

17. The method of claim 11 wherein each nozzle is configured to spray washing fluid at a pressure of from about 1500 to about 3500 psi.

18. The method of claim 11 wherein each nozzle is configured to spray washing fluid at a pressure of from about 2000 to about 3000 psi.

19. The method of claim 11 wherein each nozzle is in a fixed transverse position.

20. The method of claim 11 wherein the nozzle spray paths are directed toward a web that is a continuous loop web.

21. The method of claim 11 wherein two separate and distinct spray paths are sprayed at one time and on either side of an unsprayed path.
